(19) United States
(12) Patent Application Publication
(10) Pub. No.: US 2014/0117843 A1
(43) Pub. Date: May 1, 2014

(54) ELECTROLUMINESCENT DISPLAY AND METHOD FOR PRODUCTION

(71) Applicant: Scott Huffer, Hartsville, SC (US)

(72) Inventor: Scott Huffer, Hartsville, SC (US)

(21) Appl. No.: 13/663,783

(22) Filed: Oct. 30, 2012

(51) Int. Cl. H05B 33/22; H05B 33/10

(52) U.S. Cl. 313/509; 445/24

(57) ABSTRACT

The present invention relates to an electroluminescent display. The display includes a transparent conductive film layer, a first transparent dielectric layer, a light emitting layer, a second dielectric layer, and a rear conductive layer. The rear conductive layer defines a continuous void, where the void separates the rear conductive layer into a first area to be energized to electroluminate and a second area that is not energized.

### FIELD OF THE INVENTION

The present invention relates generally to electroluminescent displays, and more particularly to localized electroluminescent displays that effectively utilize energy for illumination.

### BACKGROUND OF THE INVENTION

Electroluminescent panels or lamps provide illumination for a wide array of objects such as watches, vehicle instrument panels, computer monitors, etc. These electroluminescent panels may be formed by positioning an electroluminescent material between two electrodes. The electric field created when applying an electric current to the electrodes causes excitation of the electroluminescent material and emission of light therefrom.

### SUMMARY OF THE INVENTION

According to an aspect, the present invention provides an electroluminescent display that includes a transparent conductive film layer; a first transparent dielectric layer; a light emitting layer; a rear conductive layer defining a continuous void, where the continuous void separates the rear conductive layer into a first area to be energized for electroillumination and a second area that is not energized, and a protective layer. In certain embodiments, the protective layer may comprise an adhesive and/or may be a second dielectric layer.

According to another aspect, the present invention provides a method for the production of an electroluminescent display including layering materials to achieve a layered substrate having layers in the following order: a transparent conductive film layer; a first transparent dielectric layer; a light emitting layer; a rear conductive layer; and a protective layer. In certain embodiments, the protective layer comprises an adhesive and/or may be a second dielectric layer. The method further includes removing a portion of the rear conductive layer such that two distinct sections of the rear conductive layer remain, where a first area of the rear conductive layer forms a part of the electroluminescent display and where a second area of the rear conductive layer is not part of the electroluminescent display.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is an enlarged side view of a electroluminescent display in accordance with an embodiment of the present invention;

FIG. 2 is an exploded view of the component layers of the electroluminescent display of FIG. 1;

FIG. 3A is an enlarged side view of a rear conductive layer attached to a substrate by an adhesive;

FIG. 3B is an enlarged side vi he rear conductive layer of FIG. 3A defining a continuous void;

FIG. 4A is a top view of a rear conductive layer of the present invention;

FIG. 4B is a top view of the rear conductive layer of FIG. 4A defining a continuous void;

FIG. 4C is a top view of a die-cut portion of the rear conductive layer of FIG. 4A; and

FIG. 5 is a perspective view of packaging materials having an electroluminescent display in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to certain embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

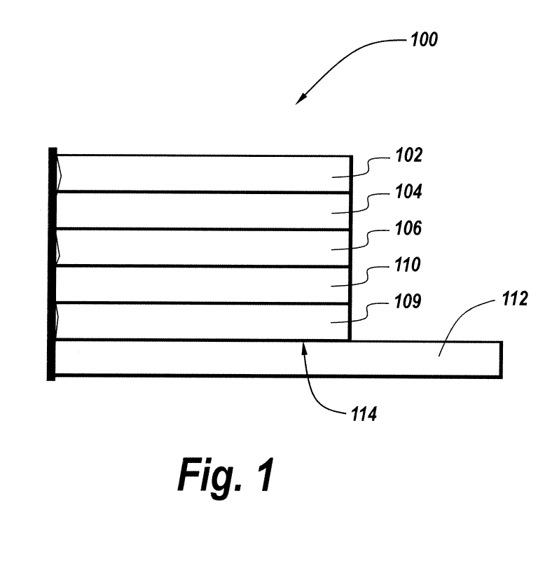

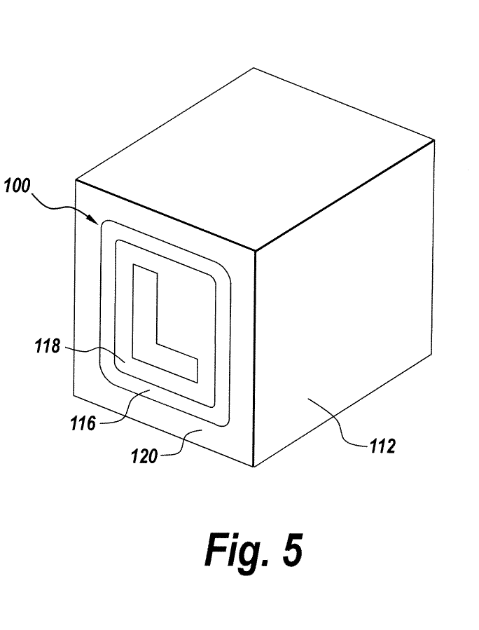

An electroluminescent display 100 in accordance with an embodiment of the present invention is shown in FIGS. 1 and 5. As shown in FIG. 1, electroluminescent display 100 may comprise a number of component layers including a transparent conductive film 102, a first transparent dielectric layer 104, a light emitting layer 106, a rear conductive layer 110 and a protective layer 109 which may be a second, optional, dielectric layer 109. Utilizing the present invention along with a power source (not shown), electrical energy causes light emitting layer 106 to illuminate and create a desired display that is displayed through the transparent layers 102 and 104.

The electroluminescent display component layers 102-110 may be formed of materials known in the art for use with electroluminescent items. For instance, first transparent dielectric layer 104 and second dielectric layer 109, if used, may be formed of and/or comprise a high dielectric constant material, such as barium titanate. One particular transparent dielectric that can be utilized for first transparent dielectric layer 104 and/or second dielectric layer 109, is a DuPont® brand dielectric paste (750 g). Second dielectric layer 109, when used, may as an encapsulating, protective rear layer in order to insulate any electrical transmissions within the display and prevent electrical shorting. Light emitting layer 106 may be formed of materials that illuminate upon being positioned and/or energized in an electric field. Such materials may include non-organics, such as phosphor, or organics, such as light emitting polymers. One particular product that can be used in the light emitting layer 106 is an Allied® brand photochemical phosphor TGH1400WHBB Batch 26. Conductive rear layer 110 may be formed of conductive particles, e.g., silver or carbon, dispersed in a polymeric or other binder to form a screen printable ink. In other embodiments, conductive rear layer 110 may be formed of aluminum foil that may be bonded with a conductive material, including but not limited to, conductive epoxy. One particular product that can be utilized for the conductive rear layer is 0.0003 aluminum foil A wetable-shiney matte side. In most instances, conductive rear layer 110 is typically opaque, particularly when a one-way illuminated display is desired.

The rear protective layer 109 may be a film laminated with Henkel® brand 393 adhesive to the foil. In addition, conductive adhesive may be used to bond the foil to the light emitting layer (e.g., phosphor) or to bond the foil to the protective layer 109 to assist in the conducting of electrical charges.

In some embodiments of the present invention, transparent conductive film 102 may be constructed of a transparent conductive material on a substrate. In such embodiments, the transparent conductive material may be formed in a single or a plurality of layers in a grid-like pattern and may be constructed of silver, copper, aluminum, gold, conductive polymers, conductive carbons, or other transparent conductive materials known in the art. Further, in such embodiments, the substrate utilized for the transparent conductive film may include polymers, for example, polypropylene, polymethylpentene, polyethylene including polyester, and others. In some embodiments of the present invention, transparent conductive films utilizing the tradename PolyIC® from PolyIC Gmbh & Co. of Bavaria, Germany may be utilized, where it has been found that the conductivity of such film may be more than 10 times greater than that of traditional components of electroluminescent materials. One particular type of transparent film that may be utilized in the present invention is a 50 micron, PolyIC® silver grid film on PET. In further embodiments, transparent conductive film 102 may be created from conductive polymers including but not limited to, polyaniline, polypyrrole, or polyethylene-dioxithiophene. In the grid-like pattern embodiments, the transparent clear conductive layer may include a grid-like pattern comp sing a conductive material applied to a clear film, such as is the case with PolyIC® wherein a silver grid is carried on a clear film. In another embodiment, a grid-like pattern may be printed on a clear film using a conductive ink such as Vor-ink™. which is a grapheme-based ink in conductive carbon-containing ink) available from Vorbeck Materials of Jessup, Md. The exact components of the layers may be modified or chosen based on the results and feature desired or the specifications for engineering the particular characteristics of the electroluminescent display.

The resulting conductive layer 102 utilized in the present invention is a clear conductive film that allows light to pass therethrough. The use of the transparent conduct film layer 102 avoids the need for the use of expensive translucent conductor layers as in some prior art devices. In addition, the use of the layers of the present invention avoids the need for the use of expensive silver-containing components that are typically utilized in prior art constructs.

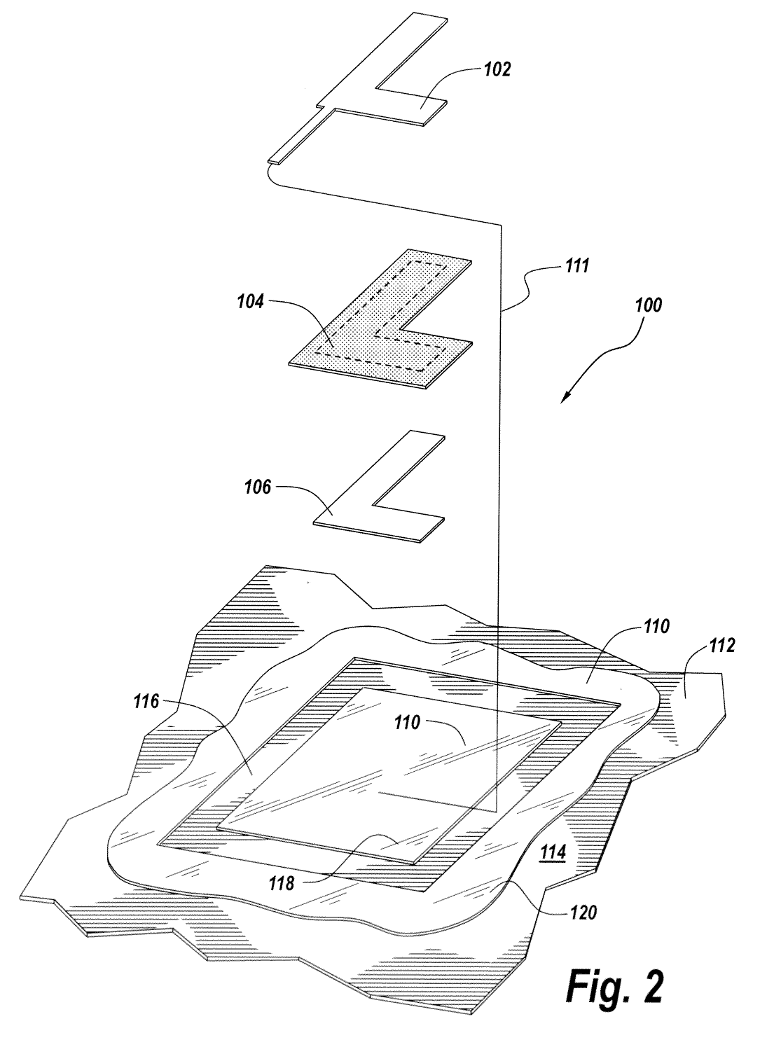

As shown in FIG. 1, the electroluminescent display component layers 102-110 are successively applied to one another with an electrical connection 111 (as shown in FIG. 2) between transparent conductive film layer 102 and conductive rear layer 110 such that electroluminescent display 100 may be illuminated. In further embodiments of the present invention, first transparent dielectric layer 104 may be positioned such that it is between light emitting layer 106 and rear conductive layer 110. In addition, in some embodiments and as shown in FIG. 1, electroluminescent display 100 may be applied to a substrate 112 to form a base layer in which the electroluminescent display component layers 102-110 are formed. Substrate 112 may be a packaging material, for instance corrugated fiberboard or paperboard, a fabric or textile material, or other materials known in the art. The user's application of electroluminescent display 100 will dictate the necessary material employed as substrate 112.

Each of the electroluminescent display component layers 102-110 may be successively applied by any means known in the art. For example, component layers may be applied with adhesives or other binding materials or by printing (e.g., flexographic or gravure), stenciling, flat coating, brushing, rolling, and spraying. In other embodiments, component layers 102-110 may be printed onto a substrate by screen or ink jet printing, but the exact means of application will be dictated by the engineering specifications and the processing parameters utilized.

As shown in FIG. 2, in fabricating the electroluminescent display 100, rear conductive layer 110 and second dielectric layer 109 (not shown) may be applied onto a front surface 114 of substrate 112 if a substrate is utilized. Rear conductive layer 110 and second dielectric layer 109 may be applied generally as a sheet layer covering the entire substrate 112, or may be patterned in a specific arrangement onto front surface 114. Light emitting layer 106 may then applied over rear conductive layer 110. The surface area dimensions of light emitting layer 106 define the illumination area for electroluminescent display 100 and may vary based on the use of and desired characteristics of the electroluminescent display. First transparent dielectric layer 104 may then applied over light emitting layer 106 or over rear conductive layer 110 as discussed above, and it may cover any surface area based on the specifications of use. The layers may be generally applied in any order, provided the arrangement of the layers in the layered substrate described is achieved.

The materials chosen for transparent conductive film 102 and first transparent dielectric layer 104 are ones that are light-transmissive (i.e. transparent or translucent) such that the illumination provided by light emitting layer 106 may be viewed above electroluminescent display 100 by an observer. During fabrication, the transparent conductive film 102 serves as the print substrate onto which ink is deposited. First transparent dielectric layer 104 is typically initially applied to the transparent conductive film 102, typically by reverse printing to allow the outside surface to function as a protective barrier. The light emitting layer 106 is then applied to the combined first transparent dielectric layer 104 and transparent conductive film 102. To control the bonding or adhesion between layers, the chemistry of the layers may be engineered to promote more or less adhesion as necessary.

In some embodiments, transparent conductive film 102 extends to cover light emitting layer 106 but does not extend beyond the perimeter of first transparent dielectric layer 104. In such an embodiment, transparent conductive film 102 works in conjunction with rear conductive layer 110 to provide a relatively consistent electric field across the entire surface of light emitting layer 106 to ensure relatively even illumination of electroluminescent display 100. Once the layers have been properly applied, transparent conductive film 102 and rear conductive layer 110 are electrically connected to supply electrical energy to electroluminescent display 100 from a power source (not shown), thereby illuminating light emitting layer 106.

Utilizing the above-described electroluminescent display 100, the present invention further includes a continuous void 116 applied to rear electrode layer 110 as more clearly shown in FIG. 2. Continuous void 116 is located outside of the boundaries of the surface area covered by light emitting layer 106 such that electroluminescent display 100 is localized within a first area 118 of rear conductive layer 110 that be energized. Continuous void 116 further creates a second area 120 of the rear conductive layer 110 that does not require electrical energy due to the absence of any electroluminescent display 100 in second area 120. Such an arrangement allows for electrical energy to be localized to first area 118, whereby electrical energy is not wasted by providing it to second area 120 where there is no electroluminescent display 100.

Continuous void 116 may be created by any means known in the art. For example, in some embodiments, continuous void 116 may be created by die-cutting rear conductive layer 110 and second dielectric layer 109. In other embodiments, continuous void 116 may be created by shearing or other forms of cutting. As indicated above, continuous void 116 aids in creating a first area 118 of rear conductive layer 110 that is energized and forms part of the electroluminescent display and a second area 120 that is not energized and which is not part of the electroluminscent display. Any manner or means of removal of material to be energized may be utilized, provided this result is achieved.

In other embodiments contemplated by the present invention, continuous void 116 may be created by the application of a material onto rear conductive layer 110 that interrupts the conductivity of rear electrode layer 110. As such, the material applied to create continuous void 116 would provide the necessary first and second areas 118, 120 as described above.

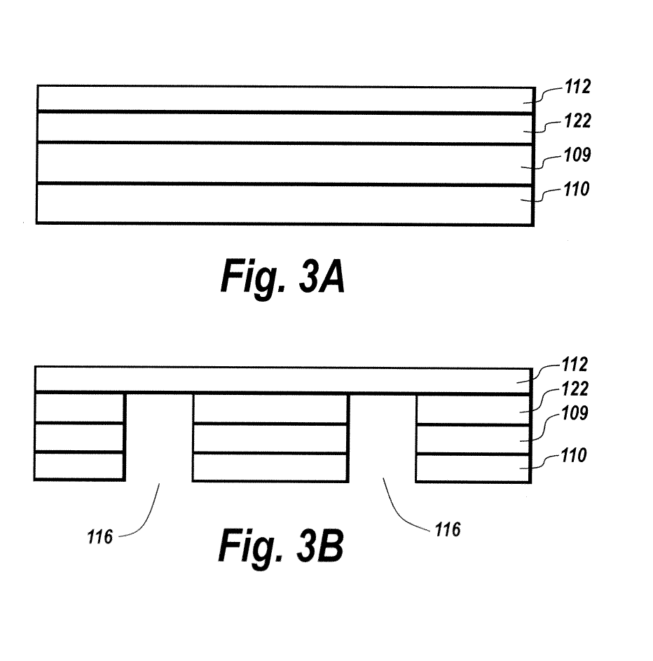

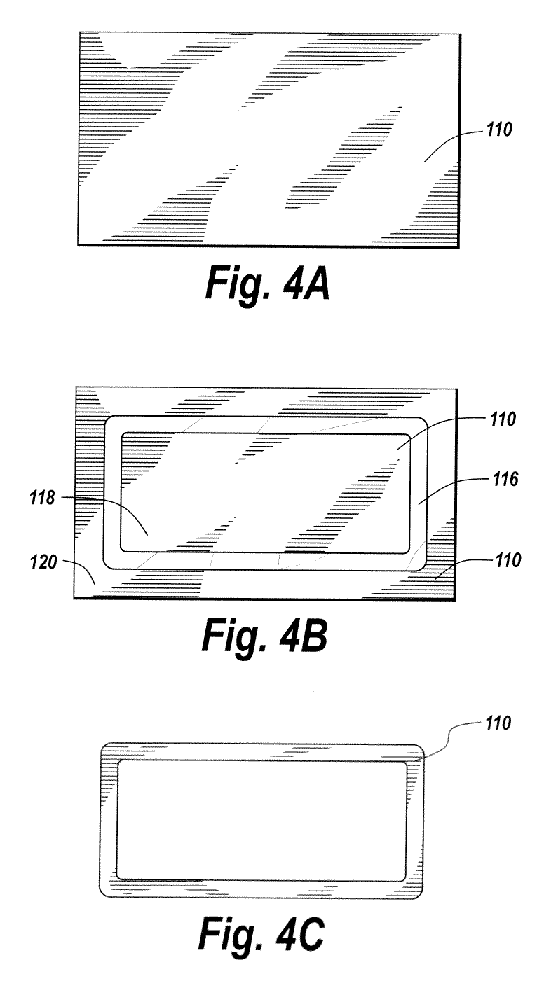

An example of the creation of continuous void 116 is illustrated in FIGS. 3A and 38 and FIGS. 4A through 4C. In the representative example shown in the Figures, rear conductive layer 110 and second dielectric layer 109 are applied to a substrate 112 with the use of adhesive 122 as more clearly shown in FIGS. 3A and 3B. Rear conductive layer 110 and second dielectric layer 109 are then die-cut resulting in first area 118, which will include electroluminescent display 100, second area 120 and continuous void 116 in between, as shown in FIGS. 3B and 4B. The resulting die-cut piece of rear conductive layer 110, shown in FIG. 4C, may be discarded as it may no longer serve a function with the present invention.

In embodiments of the present invention and as indicated above, rear conductive layer may be formed of aluminum foil, where it is applied to a packaging material substrate as shown in FIG. 5. The selection of aluminum foil may be advantageous in the present invention due to its conductive properties and relatively low costs. In embodiments where aluminum foil is utilized, the use of any form of aluminum foil is contemplated in the present invention. For example, the thickness of aluminum foil utilized in the present invention may range from 0.2 mils to 8 mils. The user's specifications will dictate the necessary materials utilized as the conductive layer and the substrate to which it is applied.

As indicated above, aluminum foil may be advantageous due to its versatility in connection with the present invention. If the electroluminescent display 100 is utilized on packaging material substrates, aluminum foil may serve multiple purposes. For instance, packaging materials typically require the addition of layers with barrier properties to protect them from certain elements, e.g. liquids, light and others. Utilizing aluminum foil as the rear conductive layer 110 may provide both the desired barrier properties as well as the desired conductive material necessary for creating electroluminescent display 100. When aluminum foil is used as the rear conductive layer, it is bonded to the structure with either a thin layer of non-conductive adhesive or a conductive adhesive that adheres the foil in the structure as well as promoting conductivity. In such an embodiment, multiple types of materials are not necessary to perform each of the required functions with the present invention.

In addition, the present invention may aid in the efficient production of such packaging materials with electroluminescent displays. For instance, utilizing the methods of the prior art, an additional step of adhering a localized rear conductive layer on top of an outer packaging layer is necessary for the display. However, utilizing the above described invention, the use of aluminum foil for the electroluminescent display 100 is combined with the addition of the protective or barrier layer, reducing the number of steps necessary for creating the desired packaging materials.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

1. An electroluminescent display comprising:
a transparent conductive film layer;
a first transparent dielectric layer;
a light emitting layer;
a rear conductive layer defining a continuous void, wherein the void separates the rear conductive layer into a first area to be energized to electroluminate and a second area that is not energized; and
a rear protective layer.

2. The electroluminescent display of claim 1, wherein the transparent conductive film layer comprises a conductive material in a grid-like pattern.

3. The electroluminescent display of claim 2, wherein the conductive material comprises silver, copper, conductive carbon, or mixtures thereof.

4. The electroluminescent display of claim 2, wherein the transparent conductive film layer further comprises a substrate in communication with the conductive material,

5. The electroluminescent display of aim 4, wherein the substrate comprises polyester.

6. The electroluminescent display of claim 1, wherein the rear conductive layer comprises aluminum

7. The electroluminescent display of claim 1, wherein the continuous void is die-cut from the rear conductive layer.

8. The electroluminescent display of claim 1, wherein the rear conductive layer comprises a substrate.

9. The electroluminescent display of claim 1, wherein the protective layer comprises a second dielectric layer.

10. The electroluminescent display of claim 1, wherein the protective layer comprises an adhesive.

11. The electroluminescent display of claim 10, wherein the adhesive is a pattern-applied adhesive.

12. An electroluminescent display comprising:
a transparent conductive film layer;
a first transparent dielectric layer;
a phosphor layer;
an aluminum foil layer defining a continuous void, wherein the void separates the aluminum foil layer into a first area to be energized to electroluminate and a second area that is not energized;
a protective layer; and
a paperboard substrate.

13. The electroluminescent display of claim 2, wherein the continuous void is die-cut from the aluminum foil layer.

14. The electroluminescent display of claim 12, wherein the transparent conductive film layer comprises a conductive material in a grid-like pattern.

15. The electroluminescent display of claim 12, wherein the protective layer comprises a second dielectric layer.

16. A method for the production of an electroluminescent substrate comprising:
layering materials to achieve a layered substrate having layers in the following order:
a transparent conductive film layer;
a first transparent dielectric layer;
a light emitting layer; and
a rear conductive layer; and
a protective layer; and
removing a portion of the rear conductive layer such that two distinct sections of the rear conductive layer remain,
wherein a first area of the rear conductive layer forms a part of the electroluminescent display and wherein a second area of the rear conductive layer is not part of the electroluminescent display.

17. The method of claim 16, wherein the rear conductive layer comprises aluminum foil.

18. The method of claim 6, wherein the protective layer comprises an adhesive.

19. The method of claim 16, wherein the removal of a portion of he rear conductive layer s performed through die-cutting.

20. The method of claim 16, wherein the method further comprises layering the layered substrate onto another substrate.

21. The method of claim 20, wherein the substrate is a packaging material.

22. The method of claim 21, wherein the packaging material is paperboard.

23. The method of claim 16, wherein the light emitting layer comprises phosphor.

24. The method of claim 16, wherein the transparent conductive film layer comprises a conductive material in a grid-like pattern.

25. The method of claim 24, wherein the transparent conductive film layer further comprises a substrate in communication with the conductive material.
